(19) United States
(12) Patent Application Publication
(10) Pub. No.: US 2017/0372014 A1
(43) Pub. Date: Dec. 28, 2017

(54) SEARCH METHOD AND SEARCH APPARATUS

(71) Applicant: FUJITSU LIMITED, Kawasaki-shi (JP)

(72) Inventor: Tadaaki KATSUDA, Bunkyo (JP)

(73) Assignee: FUJITSU LIMITED, Kawasaki-shi (JP)

(21) Appl. No.: 15/672,874

(22) Filed: Aug. 9, 2017

Related U.S. Application Data
(63) Continuation of application No. PCT/JP2015/056638, filed on Mar. 6, 2015.

(51) Int. Cl. G06F 19/00; G06F 17/30

(52) U.S. Cl. CPC G06F 19/322; G06F 17/30979; G06F 19/326

(57) ABSTRACT

A search apparatus includes a storage unit and an operating unit. The storage unit stores therein at least a plurality of representative patient information records, which are representatives of patient information groups each being a set of patient information records that are similar to each other, among a plurality of patient information records about a plurality of patients. The operating unit finds a first patient information record with the highest degree of similarity to a specified patient information record from among the representative patient information records. The operating unit then finds a second patient information record with the highest degree of similarity to the specified patient information record from among the patient information records included in the patient information group to which the first patient information record belongs.

### CROSS-REFERENCE TO RELATED APPLICATION

This application is a continuation application of International Application PCT/JP2015/056638 filed on Mar. 6, 2015 which designated the U.S., the entire contents of which are incorporated herein by reference.

### FIELD

The embodiments discussed herein relate to a search method and a search apparatus.

### BACKGROUND

A study has been conducted on the use of databases in medical fields. For example, there is a study on how to search for similar cases using a database that contains a large amount of patient information including examination results and diagnosis results with respect to individual patients. Such study is in progress using, as an example of the database, the integrative disease omics database, in which clinical pathology information, image diagnosis data, and genome and omics data from lesions are integrated with respect to each individual patient.

In addition, the following technique has been proposed as one of techniques for matching between an original image and a template image. The proposed technique uses hierarchical images that are produced by changing the resolutions of the original image. In the matching, the uppermost-layer image of lowest resolution is used first. A plurality of point groups that have correlation values with the template image greater than or equal to a threshold are extracted from the uppermost-layer image, and then a point with the greatest correlation value is detected in each point group as a search point.

See, for example, Japanese Laid-open Patent Publication No. 7-49949.

In a process of searching a database containing the above-described patient information to find patient information similar to the patient information of a specified patient, the search takes more time as the database contains more information. This is a problem. For example, the search takes more time as the database contains more patient information and as the patient information has more kinds of information items.

### SUMMARY

According to one aspect, there is provided a non-transitory computer-readable storage medium storing a computer to perform a process including: retrieving, from a storage device, a plurality of representative patient information records among a plurality of patient information records about respective ones of a plurality of patients, the storage device storing therein the plurality of patient information records, the plurality of representative patient information records respectively being representatives of a plurality of patient information groups, the plurality of patient information groups each being a set of patient information records similar to each other; finding a first patient information record with a highest degree of similarity to a specified patient information record from among the plurality of representative patient information records; retrieving, from the storage device, patient information records included in a specific patient information group to which the first patient information record belongs among the plurality of patient information groups; and finding a second patient information record with a highest degree of similarity to the specified patient information record from among the patient information records included in the specific patient information group.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a search apparatus according to a first embodiment;

FIG. 2 illustrates an information processing system according to a second embodiment;

FIG. 3 illustrates an example of hardware of a server;

FIG. 4 illustrates an example of functions of the information processing system;

FIG. 5 illustrates an example of a patient database;

FIG. 6 illustrates an example of a map table;

FIG. 7 illustrates an example of a representative patient table;

FIG. 8 illustrates an example of a patient group table;

FIG. 9 illustrates an example of preprocessing for a similar patient search;

FIG. 10 is a view for explaining an example of a process of searching for a similar patient;

FIGS. 11 and 12 is a flowchart illustrating an example of preprocessing performed by a preprocessing unit; and

FIG. 13 is a flowchart illustrating an example of a similarity search process.

### DESCRIPTION OF EMBODIMENTS

Hereinafter, embodiments will be described with reference to the accompanying drawings, wherein like reference characters refer to like elements throughout.

### First Embodiment

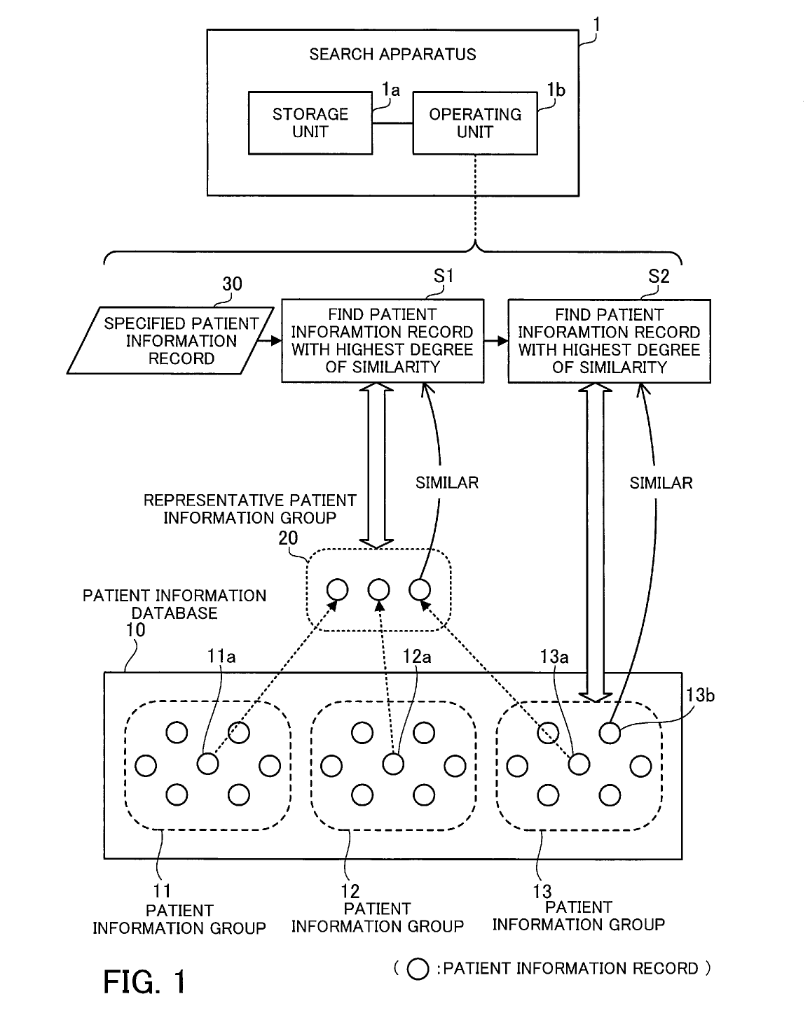

FIG. 1 illustrates a search apparatus according to a first embodiment. The search apparatus 1 searches a plurality of patient information records to find a patient information record similar to a specified patient information record or a patient corresponding to the similar patient information record. The search apparatus 1 includes a storage unit 1a and an operating unit 1b.

The storage unit 1a may be a volatile storage device, such as a Random Access Memory (RAM), or a non-volatile storage device, such as a Hard Disk Drive (HDD) or a flash memory. The operating unit 1b may be a processor, for example. Processors may include a Central Processing Unit (CPU), a Digital Signal Processor (DSP), an Application Specific Integrated Circuit (ASIC), a Field Programmable Gate Array (FPGA), and others. Alternatively, the operating unit 1b may be a multiprocessor.

The storage unit 1a stores therein a plurality of patient information records, which are searched in a similarity search. The patient information records each include various kinds of information about a patient. For example, each patient information record may include the attribute information, such as sex, diagnosis results, clinical results, implementation of treatments, a medical condition (disease), a period of time until occurrence of the medical condition, and others with respect to a patient. In this embodiment, the storage unit 1a stores therein a patient information database 10 containing a plurality of patient information records, which are searched in the similarity search, by way of example.

In this connection, the storage unit 1a of the search apparatus 1 does not need to store therein all patient information records that are searched in the similarity search. For example, it is so designed that the plurality of patient information records are stored in an external device, which is provided externally to the search apparatus 1, and the search apparatus 1 may retrieve only needed patient information records from the external device and store them in the storage unit 1a.

By the way, the patient information records in the patient information database 10 are classified into a plurality of patient information groups in advance. Each patient information group consists of a set of similar patient information records. Referring to the example of FIG. 1, the patient information records in the patient information database 10 are classified into three patient information groups 11 to 13. Note that each patient information record in the patient information database 10 may belong to a plurality of patient information groups.

One of the patient information records belonging to each patient information group is set as a representative of the patient information group. Referring to the example of FIG. 1, a patient information record 11a among the patient information records belonging to the patient information group 11 is set as a representative patient information record. A patient information record 12a among the patient information records belonging to the patient information group 12 is set as a representative patient information record. A patient information record 13a among the patient information records belonging to the patient information group 13 is set as a representative patient information record. In this connection, FIG. 1 indicates a set of the patient information records 11a, 12a, and 13a, which are the representatives of the patient information groups 11 to 13, as a representative patient information group 20.

It is desirable that these representative patient information records have as low degrees of similarity to each other as possible. For example, such representative patient information records are selected from the patient information records of the patient information database 10 using a coordinate space. This coordinate space is set such that a distance between points corresponding to patient information records represents the degree of non-similarity between the patient information records. With reference to the coordinate space where the patient information records of the patient information database 10 are mapped, a plurality of patient information records that are distributed in the coordinate space are selected as the representative patient information records.

In this connection, the process of selecting patient information records to be included in each patient information group and the process of selecting a representative patient information record of each patient information group may be performed by the search apparatus 1 or another apparatus.

The operating unit 1b receives a notification about a specified patient information record 30, which is used as a search key. Then, the operating unit 1b performs a search process to search the representative patient information records (that is, the patient information records 11a, 12a, and 13a included in the representative patient information group 20) of the respective patient information groups 11 to 13, among the patient information records of the patient information database 10. More specifically, the operating unit 1b calculates the degree of similarity between the specified patient information record 30 and each representative patient information record, and finds a patient information record with the highest degree of similarity to the specified patient information record 30 from the representative patient information records (step S1). In the example of FIG. 1, it is assumed that the representative patient information record 13a of the patient information group 13 is found.

Then, the operating unit 1b performs a search process to search the patient information group 13 to which the found patient information record 13a belongs. More specifically, the operating unit 1b calculates the degree of similarity between the specified patient information record 30 and each patient information record belonging to the patient information group 13, and finds a patient information record with the highest degree of similarity to the specified patient information record 30 from the patient information records belonging to the patient information group 13 (step S2).

In the example of FIG. 1, it is assumed that the patient information record 13b is found. The operating unit 1b outputs the found patient information record 13b or the identification information of the patient corresponding to the patient information record 13b, as a search result, for example.

As described above, in the first embodiment, the search apparatus 1 limits the search targets to the patient information records belonging to the representative patient information group 20 and the patient information records belonging to the patient information group corresponding to one representative patient information record. This reduces the number of operations for calculating the degree of similarity between patient information records, compared with the case of searching all patient information records of the patient information database 10. As a result, it is possible to perform the similarity search in a shorter time.

In addition, the patient information records are classified into a plurality of patient information groups, each of which is a set of patient information records similar to each other. The patient information records that are the representatives of the patient information groups are searched first. Thereby, a representative patient information record with the highest degree of similarity to the specified patient information record is found, and then the patient information group to which the found representative patient information record belongs, that is, a plurality of patient information records similar to the found representative patient information record are searched next. This approach reduces the risk of excluding a patient information record that is actually the most similar to the specified patient information record from being searched, among the patient information records contained in the patient information database 10. Therefore, it is possible to perform the similarity search in a shorter time while maintaining search accuracy.

In this connection, as described earlier, the storage unit 1a of the search apparatus 1 does not need to store therein all the patient information records of the patient information database 10 to be searched. For example, in the case where the patient information database 10 is stored in an external device, the search apparatus 1 reads, from the external device to the storage unit 1a, at least the representative patient information records included in the representative patient information group 20 and the patient information records belonging to the patient information group to which the patient information record found at step S1 belongs.

### Second Embodiment

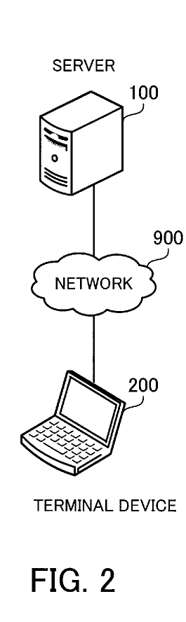

FIG. 2 illustrates an information processing system according to a second embodiment. The information processing system of the second embodiment includes a server 100 and a terminal device 200. The server 100 and terminal device 200 are connected over a network 900. The network 900 may be a Local Area Network (LAN), a Wide Area Network (WAN), the Internet, or another network.

The server 100 stores therein a patient database containing a plurality of patient information records. Each patient information record includes plural kinds of information items relating to a patient. For example, the information items include the attribute information, such as sex, diagnosis results, clinical results, implementation of treatments, a medical condition, a period of time until occurrence of the medical condition, and others with respect to a patient.

In addition, when receiving a search request from the terminal device 200, the server 100 searches the patient database to find a patient whose patient information record is similar to that of a specified patient, and sends this result to the terminal device 200. This search is called “similar case search”. In the following, a patient specified in a search request is referred to as a “query patient”, and a patient extracted from the patient database by the search is referred to as a “similar patient”.

In this connection, the server 100 is an example of the search apparatus 1 of FIG. 1.

The terminal device 200 is a client computer that is used by a user.

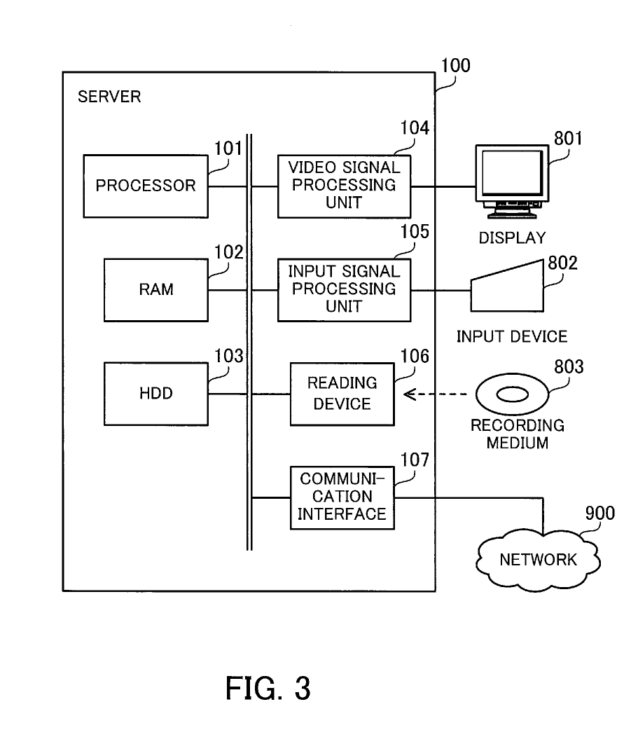

FIG. 3 illustrates an example of hardware of a server. The server 100 includes a processor 101, a RAM 102, an HDD 103, a video signal processing unit 104, an input signal processing unit 105, a reading device 106, and a communication interface 107. These units are connected to a bus of the server 100.

The processor 101 entirely controls the server 100. The processor 101 may be a CPU, a DSP, an ASIC, an FPGA, or another, for example. Alternatively, the processor 101 may be a multiprocessor including a plurality of processing elements. In addition, the processor 101 may be a combination of two or more units selected from the CPU, DSP, ASIC, FPGA, and others.

The RAM 102 is a primary storage device of the server 100. The RAM 102 temporarily stores therein at least part of Operating System (OS) programs and application programs that are executed by the processor 101. In addition, the RAM 102 stores therein various data that is used by the processor 101 in processing.

The HDD 103 is an auxiliary storage device of the server 100. The HDD 103 magnetically writes and reads data to and from a built-in disk. The HDD 103 stores therein OS programs, application programs, and various data. The server 100 may be provided with another kind of auxiliary storage device, such as a flash memory or Solid State Drive (SSD), or a plurality of auxiliary storage devices.

The video signal processing unit 104 outputs images to a display 801 connected to the server 100, in accordance with instructions from the processor 101. As the display 801, a Cathode Ray Tube (CRT) display, a Liquid Crystal Display (LCD), an organic Electro-Luminescence (EL) display, or another kind of display may be used.

The input signal processing unit 105 receives an input signal from an input device 802 connected to the server 100, and outputs the input signal to the processor 101. As the input device 802, a pointing device, such as a mouse or a touch panel, a keyboard, or another kind of input device may be used. Plural kinds of input devices may be connected to the server 100.

The reading device 106 reads programs and data from a recording medium 803. As the recording medium 803, a magnetic disk, such as a Flexible Disk (FD) or an HDD, an optical disc, such as a compact disc (CD) or a Digital Versatile Disc (DVD), a Magneto-Optical disk (MO) may be used, for example. In addition, a non-volatile semiconductor memory, such as a flash memory card, may be used as the recording medium 803. The reading device 106 loads programs and data from the recording medium 803 to the RAM 102 or HDD 103 in accordance with instructions from the processor 101, for example.

The communication interface 107 performs communication with the terminal device 200 over the network 900. The communication interface 107 may be a wired communication interface or a wireless communication interface.

In this connection, the terminal device 200 may be configured with the same hardware as the server 100.

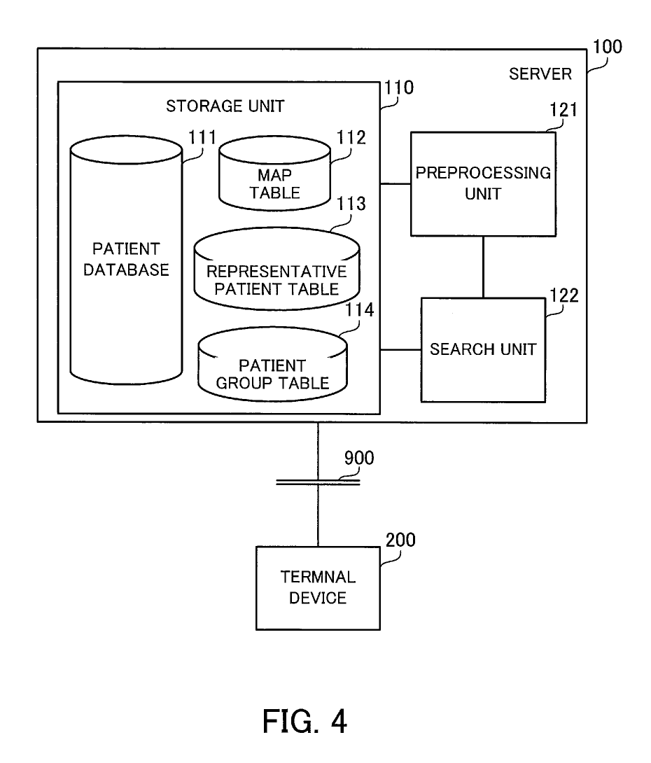

FIG. 4 illustrates an example of functions of the information processing system. The server 100 includes a storage unit 110, a preprocessing unit 121, and a search unit 122. The storage unit 110 may be implemented as a storage space set aside in the RAM 102 or HDD 103, for example. The preprocessing unit 121 and search unit 122 may be implemented by causing the processor 101 to run intended programs, for example.

The storage unit 110 stores therein a patient database 111, a map table 112, a representative patient table 113, and a patient group table 114. The patient database 111 contains a large number of patient information records. The map table 112, representative patient table 113, and patient group table 114 are created by the preprocessing unit 121 before the search unit 122 performs a search process.

The preprocessing unit 121 performs preprocessing before the search unit 122 performs a search process to find a similar patient. The preprocessing unit 121 first transforms each patient information record, which is multidimensional information registered in the patient database 111, into low-dimensional information, i.e., two-dimensional or three-dimensional information. The preprocessing unit 121 creates a map (scatter diagram) representing the position of each patient in a coordinate space of the same dimensions as the low-dimensional information. To create the map, principal component analysis or multidimensional scaling may be employed, for example. In this created map, a distance between patients represents the degree of similarity between the corresponding patient information records.

The map table 112 contains the coordinates of each patient on the map. That is, the map table 112 is substantial information corresponding to the created map. The coordinates of each patient registered in the map table 112 represent the patient information of the patient produced by the dimension transformation.

In addition, the preprocessing unit 121 selects a plurality of representative patients from all patients with reference to the map table 112. Patients that are distributed in the distribution area of the patients on the map are selected as the representative patients. The preprocessing unit 121 registers the selected representative patients in the representative patient table 113. In this connection, the representative patient table 113 may be designed to further contain the patient information records of the representative patients stored in the patient database 111.

In addition, the preprocessing unit 121 determines a patient group corresponding to each of the selected representative patients. The patient group includes patients existing within a fixed distance from a representative patient on the map, out of all the patients. That is, patients whose patient information records are somewhat similar to that of the representative patient belong to the patient group. The identification information (patient IDs) of patients belonging to each patient group is registered in the patient group table 114.

The search unit 122 receives a search request for a similar patient, from the terminal device 200. The search request includes the patient information record of a query patient. The search request may include the patient ID identifying the query patient only. In this case, the search unit 122 retrieves the patient information record corresponding to the patient ID included in the search request from the patient database 111.

The search unit 122 calculates the degree of similarity between the patient information record of the query patient and the patient information record of each representative patient. The search unit 122 finds a representative patient whose patient information record is the most similar to that of the query patient, on the basis of the calculated degrees of similarity. The search unit 122 detects a patient group to which the found representative patient belongs, with reference to the patient group table 114. The search unit 122 then calculates the degree of similarity between the patient information record of the query patient and that of each patient belonging to the detected patient group. The search unit 122 finds a patient whose patient information record is the most similar to that of the query patient, as a similar patient on the basis of the calculated degrees of similarity. The search unit 122 sends information about the found similar patient to the terminal device 200 as a search result. The information to be sent to the terminal device 200 may be the patient ID of the similar patient or part or all information of the patient information record of the similar patient. Thereby, it is possible to display the search result on the display of the terminal device 200.

In this connection, at least the patient database 111 among the information stored in the storage unit 110 may be stored in an external storage device, which is provided external to the server 100. In this case, the server 100 obtains the patient information records registered in the patient database 111 from the external storage device, to use the obtained patient information records.

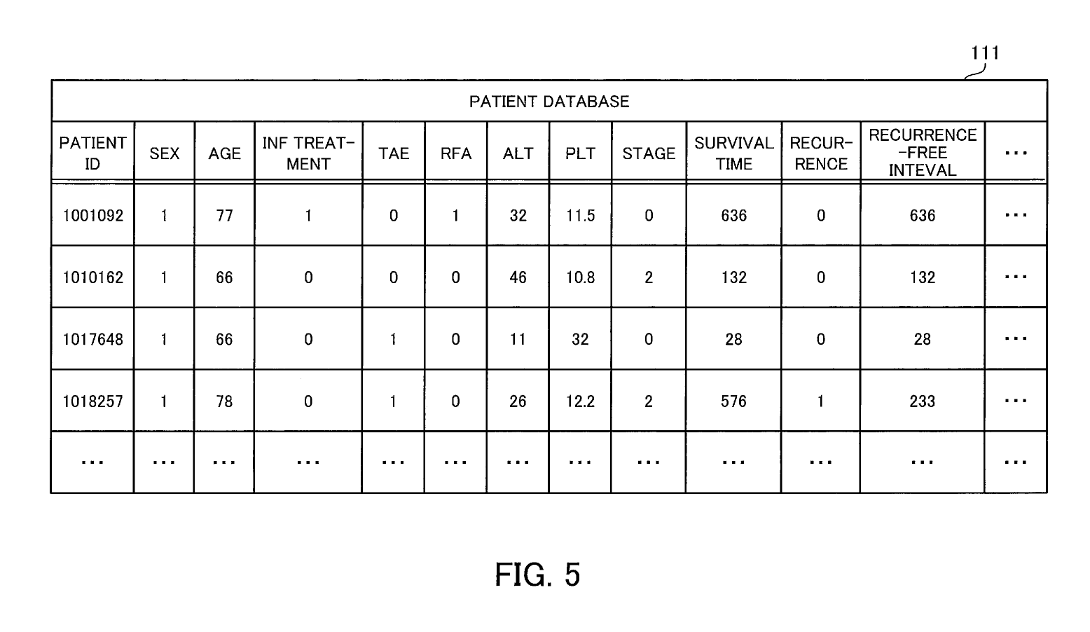

FIG. 5 illustrates an example of a patient database. The patient database 111 is stored in the storage unit 110. For example, the patient database 111 includes columns for the following information items: patient ID, sex, age, interferon (INF) treatment, Transcatheter Arterial Embolization (TAE), RadioFrequency Ablation (RFA), Alanine Aminotransferase (ALT), Platelet (PLT), stage, survival time, recurrence, and recurrence-free interval. A single record with a single patient ID in the patient database 111 is a patient information record about the patient with the patient ID.

The patient ID column contains information identifying a patient. The sex column contains information indicating sex, and has a value of “1” (male) or “0” (female). The age column contains a value indicating age.

The INF treatment column contains information indicating whether INF treatment, which is a type of treatment for hepatitis, has been done or not. This INF treatment column has a value of “1” (INF treatment has been done) or “0” (no INF treatment). The TAE column contains information indicating whether TAE, which is a type of treatment for liver cancer, has been done. The TAE column has a value of “1” (TAE has been done) or “0” (no TAE). The RFA column contains information indicating whether RFA, which is a type of treatment for liver cancer, has been done, and has a value of “1” (RFA has been done) or “0” (no RFA).

The ALT column contains an ALT test value. The PLT column contains a PLT test value. The stage column contains information indicating how far a prescribed type of cancer is spread, and has one of values “0” to “4”. As to the stage, a higher value means that cancer is more advanced. The survival time column contains information indicating the survival time from the start of a treatment.

The recurrence column contains information indicating whether a disease has recurred, and has a value of “1” (recurred) or “0” (not recurred). The recurrence-free interval column contains a value indicating how long a disease has not recurred since the start of the treatment. When a value of “1” is registered in the recurrence column, a period of time from the start of a treatment to the recurrence of the disease is registered in the recurrence-free interval column.

In the above example of FIG. 5, the sex and age are examples of the attribute information of a patient. The INF treatment, TAE, and RFA are examples of information indicating implementation of treatments for a patient. The ALT and PLT are examples of test results of a patient. The stage is an example of information indicating the condition of a patient. The recurrence is an example of information indicating whether a patient is in a certain condition. It may be said that the stage and recurrence are examples of diagnosis results of a patients. Also, it may be said that the survival time and recurrence-free interval are examples of information indicating a period of time until occurrence of a certain condition in a patient.

In addition to these, the patient database 111 may contain a gene expression level in a lesion as an example of test results of a patient. The gene expression level is registered for each DNA probe, for example. Furthermore, the patient database 111 may contain X-ray or Magnetic Resonance Imaging (MRI) images (or links to the images) as an example of test results of a patient.

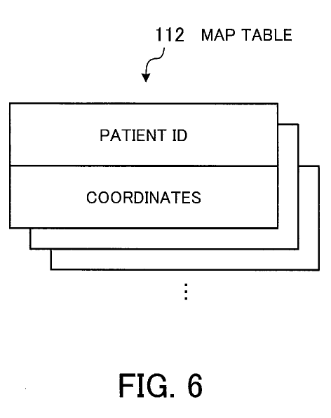

FIG. 6 illustrates an example of a map table. The map table 112 is stored in the storage unit 110. The map table 112 has a data record for each patient. Each data record includes a patient ID and coordinates. The patient ID is identification information identifying a patient. The coordinates indicate the positional information from a map. This positional information corresponds to information obtained by transforming a corresponding patient information record registered in the patient database 111 into low-dimensional information.

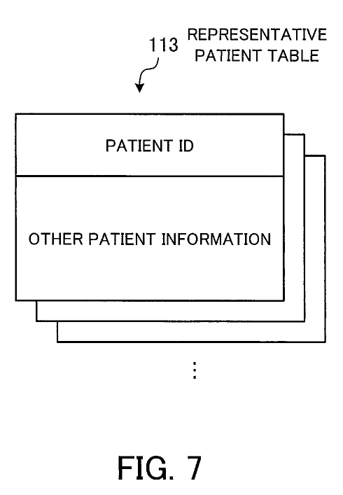

FIG. 7 illustrates an example of a representative patient table. The representative patient table 113 is stored in the storage unit 110. The representative patient table 113 has a data record for each representative patient. Each data record includes the patient information of a representative patient extracted from the patient database 111. As illustrated in FIG. 7, the data records of the representative patient table 113 are identified by patient IDs. In this connection, only the patient IDs of representative patients may be registered in the representative patient table 113.

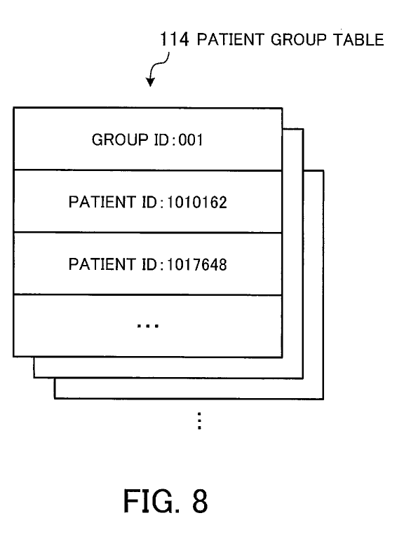

FIG. 8 illustrates an example, of a patient group table. The patient group table 114 is stored in the storage unit 110. The patient group table 114 includes a data record for each patient group. Each data record includes the group ID identifying a patient group and patient IDs identifying patients belonging to the patient group. Referring to the example of FIG. 8, patients with patient IDs “1010162” and “1017648” belong to a patient group with a group ID “001”. In this connection, the data record of a patient group includes the patient ID of the representative patient of the patient group as well.

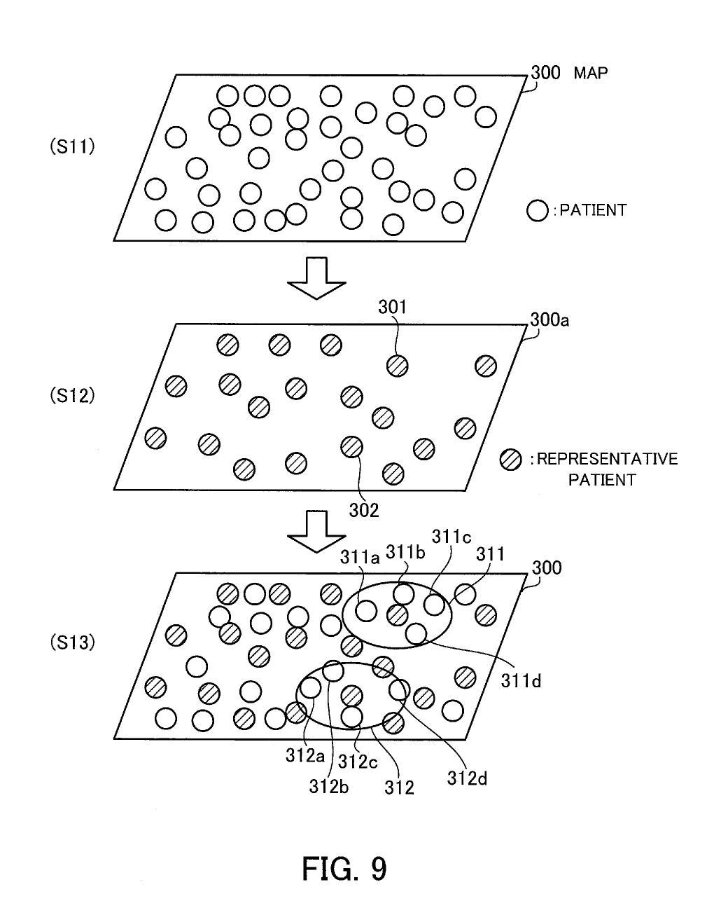

FIG. 9 illustrates an example of preprocessing for a similar patient search. The preprocessing unit 121 performs the following preprocessing to create various kinds of information for use in the similar patient search, with reference to the patient database 111.

As illustrated in FIG. 5, the patient information records registered in the patient database 111 are multidimensional information with a large number of information items. The preprocessing unit 121 first transforms each patient information record into low-dimensional information, and creates a map 300 where each patient information record is mapped based on the low-dimensional information in a coordinate space of the same dimensions as the low-dimensional information, as seen in step S11. The preprocessing unit 121 registers the coordinates indicating the mapped position of each patient information record in the low-dimensional coordinate space, in the map table 112.

In this connection, each patient information record is identified by a patient ID identifying a patient. In the following, the mapped position of each patient information record in the coordinate space forming the map 300 may be referred to a “position of a patient” on the map 300, and the coordinates representing the mapped position may be referred to the “coordinates of a patient” on the map 300.

The coordinate space forming the map 300 is set such that a distance between points represents the degree of similarity between the corresponding patient information records. More specifically, the shorter a distance between points is, the higher the degree of similarity between the corresponding patient information records is. To create such a map 300, principal component analysis or multidimensional scaling may be employed, for example.

It is desirable that the map 300 is two-dimensional or three-dimensional in order to reduce the load of processing using the map 300. In the following, it is assumed that the two-dimensional map 300 is used. In this case, each patient information record is transformed into two-dimensional information (that is, information indicating positions on two respective coordinate axes).

In the case of employing the principal component analysis, the coefficients of a linear combination expression using the values of information items of a patient information record as variables are obtained such as to provide the maximum distribution or correlation for the values of the information items. For example, in fact, the preprocessing unit 121 calculates the eigenvalues and eigenvectors of a variance-covariance matrix or correlation coefficient matrix for the values of the information items, and takes the principal component corresponding to the highest eigenvalue as a first principal component, and takes the principal component corresponding to the second highest eigenvalue as the second principal component. The preprocessing unit 121 outputs, with respect to each patient, the principal component scores corresponding to the first and second principal components, as the positional information on the respective axes in the two-dimensional coordinate space.

In the case of employing the multidimensional scaling, the preprocessing unit 121 calculates the degree of non-similarity between patient information records with respect to every combination of two patients registered in the patient database 111 (an index that has a smaller value as the degree of similarity is higher). The degree of non-similarity is calculated based on the degree of similarity, such as cosine similarity or pearson correlation coefficient, for example. The preprocessing unit 121 maps the points corresponding to the patient information records into the two-dimensional space such that the calculated degree of non-similarity between the patient information records matches the distance in the two-dimensional space. This mapping process is performed using the Young-Householder algorithm.

Then, as seen in step S12, the preprocessing unit 121 selects a prescribed number (m) of representative patients from all patients. “m” is an integer of two or greater and less than the total number of patients. Patients who are equally distributed (spread) on the map 300 are selected from all the patients as the representative patients. In this connection, the map 300a of FIG. 9 represents only the positions of the representative patients extracted from the map 300.

For example, the preprocessing unit 121 randomly selects m patients from all the patients until the following condition is satisfied.

(Condition) In the map 300, a standard deviation σ1 of the positions of all patients almost matches the standard deviation σ2 of the positions of selected patients.

Now, taking the number of patients used in the calculation as “n”, the coordinates of each patient on the map 300 as (xₙ, yₙ), the center of gravity Sd with respect to the positions of n patients as (x₀, y₀), and the standard deviation of the positions of n patients as σ, the center of gravity Sd and the standard deviation σ are calculated by the following equations (1) and (2).

$$\begin{matrix}( {x}_{0} , {y}_{0} ) = ( \frac{1}{n} {\sum }_{i = 1}^{n} {x}_{i} , \frac{1}{n} {\sum }_{i = 1}^{n} {x}_{i} ) & ( 1 ) \\ σ = \sqrt{\frac{1}{n} {\sum }_{i = 1}^{n} \{ {( {x}_{i} - {x}_{0} )}^{2} + {( {y}_{i} - {y}_{0} )}^{2} \}} & ( 2 )\end{matrix}$$

The center of gravity Sd is calculated by substituting the coordinates of all patients in the equation (1), and the standard deviation σ1 is calculated by substituting the coordinates of all the patients and the coordinates of the center of gravity Sd in the equation (2). In addition, the standard deviation σ2 is calculated by substituting the coordinates of the randomly selected patients and the coordinates of the center of gravity Sd in the equation (2). In this connection, in the calculation of the standard deviation σ2, the value of the center of gravity with respect to the positions of the randomly selected patients may be substituted in the equation (2), in place of the center of gravity Sd.

The condition is judged as follows. For example, the condition is judged to be satisfied when the absolute value of the difference between the standard deviation σ1 and the standard deviation σ2 is lower than or equal to a prescribed fraction of the standard deviation σ1 (or the standard deviation σ2). The prescribed fraction is greater than zero and smaller than one, and is 5% in percentage, for example. As another example, the condition is judged to be satisfied when the absolute value of the difference between the standard deviation σ1 and the standard deviation σ2 is lower than or equal to a prescribed threshold.

When the randomly selected patients satisfy the above condition, the preprocessing unit 121 designates each of the selected patients as a representative patient, and then registers the patient ID of each representative patient in the representative patient table 113. In addition, in the embodiment, the preprocessing unit 121 registers, not only the patient IDs of the representative patients, but also all information of the patient information records of the representative patients in the representative patient table 113.

Then, the preprocessing unit 121 determines a patient group corresponding to each of the selected representative patients, as seen in step S13. The patient group includes patients existing within a fixed distance from the representative patient on the map 300, among all patients. Thereby, patients that are somewhat similar to the representative patient belong to the patient group. In FIG. 9, for example, patients 311a to 311d belong to the patient group 311 corresponding to the representative patient 301, and patients 312a to 312d belong to the patient group 312 corresponding to the representative patient 302.

The preprocessing unit 121 creates a data record for each representative patient in the patient group table 114, and registers the patient IDs of patients belonging to the patient group corresponding to the representative patient in the corresponding data record in the patient group table 114.

In this connection, the range of distance for setting the patient groups on the map 300 are set such that at least one patient other than a representative patient belongs to a patient group. In addition, the areas of adjacent patient groups on the map 300 may overlap. This allows a patient to belong to a plurality of patient groups.

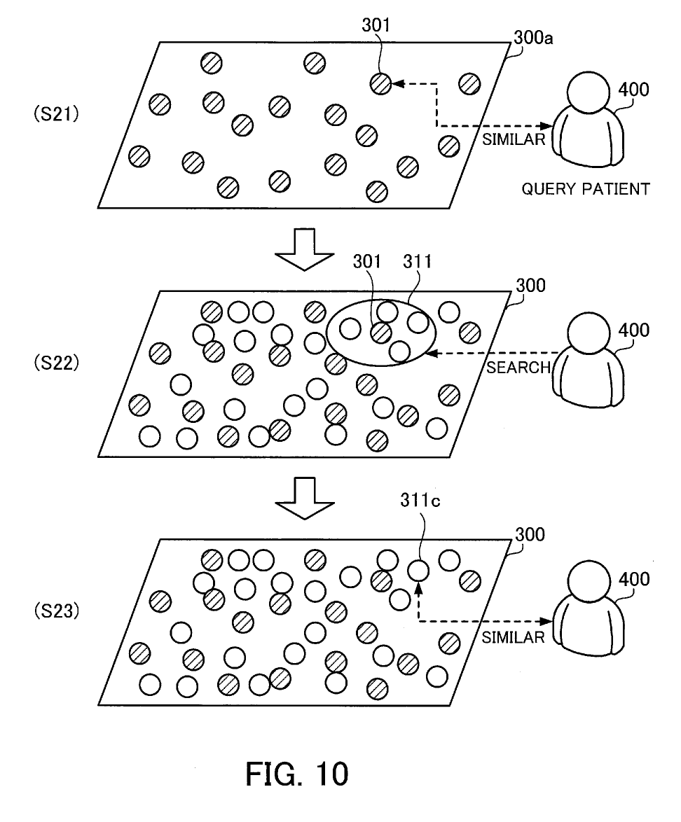

FIG. 10 is a view for explaining an example of a process of searching for a similar patient.

The search unit 122 receives a search request for a patient similar to a query patient 400, from the terminal device 200. The search unit 122 first searches only the representative patients for a similar patient. More specifically, the search unit 122 calculates the degree of similarity between the patient information record of the query patient 400 and the patient information record of each representative patient. For example, the search unit 122 calculates the degree of similarity, using cosine similarity, pearson correlation coefficient, spearman correlation coefficient, or kendall correlation coefficient.

In the case of using the cosine similarity, for example, the search unit 122 evaluates each information item included in the patient information record of the query patient 400 to create a vector. In addition, the search unit 122 evaluates each information item included in the patient information record of each representative patient to create a vector. The search unit 122 calculates the degree of similarity on the basis of the vector created based on the patient information record of the query patient and the vector created based on the patient information of the representative patient.

As seen in step S21, the search unit 122 finds a representative patient 301 whose patient information record is the most similar to that of the query patient 400 on the basis of the calculated degrees of similarity.

Then, as seen in step S22, the search unit 122 detects the patient group 311 to which the representative patient 301 belongs, with reference to the patient group table 114. Then, the search unit 122 searches the patients (including the representative patient) belonging to the patient group 311 to find a similar patient. That is, the search unit 122 calculates the degree of similarity between the patient information record of the query patient 400 and the patient information record of each patient belonging to the patient group 311. In this connection, the degree of similarity is calculated in the same way as the above-described process of searching representative patients.

As seen in step S23, the search unit 122 finds a patient 311c whose patient information record is the most similar to that of the query patient 400, from the patients belonging to the patient group 311, as a search result, for example. The search unit 122 sends the patient ID or patient information record of the found patient 311c as a search result to the terminal device 200, for example.

In the above process of FIG. 10, the search unit 122 does not search all patients registered in the patient database 111 in response to a search request, but searches only representative patients to find a similar representative patient. Then, the search unit 122 detects a patient group to which the representative patient found by the search belongs, and searches only patients belonging to the detected patient group to find a similar patient.

The above process significantly reduces the number of operations for calculating the degree of similarity between patient information records, compared with the case of searching all patients registered in the patient database 111. This leads to significantly reducing the time after the reception of a search request until the completion of the search process. For example, assume that 10,000 patients are registered in the patient database 111, there are 100 representative patients, and 100 patients belong to each patient group. In this case, the degree of similarity needs to be calculated 10,000 times to search all the patients registered in the patient database 111 to find a similar patient. With the process of FIG. 10, on the other hand, the degree of similarity needs to be calculated only as few as 200 times. That is to say, although it takes several hours to complete the search process of searching all patients, it is possible to complete the search process of FIG. 10 within several minutes or seconds.

In addition, as illustrated in FIG. 9, the map 300 is created such that a distance between patients represents the degree of similarity (more precisely, the degree of non-similarity) between the corresponding patient information records, and a plurality of patients that are distributed as much as possible on the map 300 are selected as representative patients. Then, as illustrated in FIG. 10, a patient group to which a representative patient whose patient information record is similar to that of a query patient belongs is detected, and then the patients belonging to the detected patient group are searched in a detailed search. This approach reduces a risk of excluding a patient whose patient information record is actually the most similar to that of the query patient, from being searched. As a result, it is possible to perform the search in a shorter time while maintaining the search accuracy.

The following describes how the server 100 operates, with reference to flowcharts.

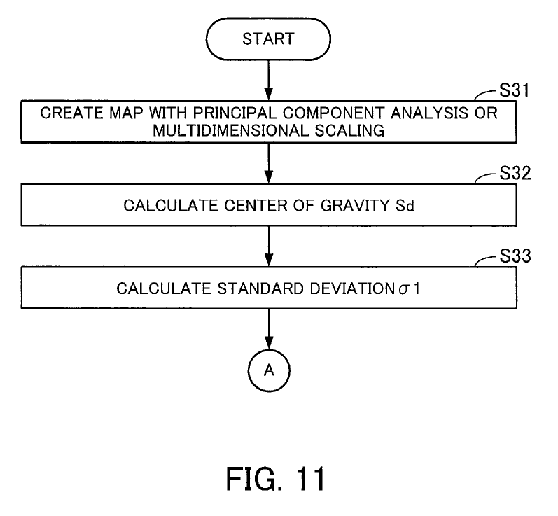

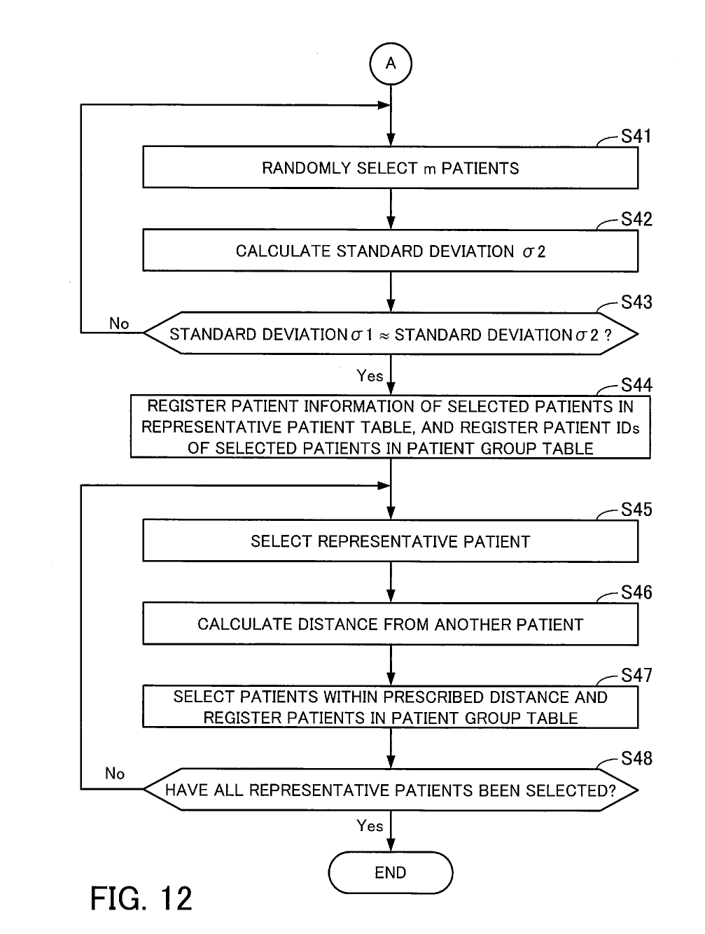

FIGS. 11 and 12 are a flowchart illustrating an example of preprocessing performed by the preprocessing unit. The process of FIGS. 11 and 12 will be described step by step. The process of FIGS. 11 and 12 is performed at regular intervals, for example, once a week.

(S31) The preprocessing unit 121 creates a map, using principal component analysis or multidimensional scaling and on the basis of the patient database 111. In fact, the preprocessing unit 121 registers the correspondence between the patient ID of each patient registered in the patient database 111 and the coordinates of the patient on the map, in the map table 112.

(S32) The preprocessing unit 121 calculates the center of gravity Sd with respect to the positions of all patients on the map. The center of gravity Sd is calculated by substituting the coordinates of all the patients read from the map table 112, in the above equation (1).

(S33) The preprocessing unit 121 calculates the standard deviation σ1 of the positions of all the patients on the map. The standard deviation σ1 is calculated by substituting the coordinates of all the patients read from the map table 112 and the coordinates of the center of gravity Sd calculated in step S32, in the above equation (2). Then, the process proceeds to step S41.

Refer to FIG. 12.

(S41) The preprocessing unit 121 randomly selects m patients from the patients registered in the map table 112 (or the patient database 111).

(S42) The preprocessing unit 121 calculates the standard deviation σ2 of the positions of the patients selected at step S41. The standard deviation σ2 is calculated by substituting the coordinates of the patients selected at step S41, read from the map table 112, and the center of gravity Sd calculated in step S32, in the above equation (2).

(S43) The preprocessing unit 121 determines whether the standard deviation σ1 calculated at step S33 almost matches the standard deviation σ2 calculated at step S42. That is to say, the preprocessing unit 121 determines whether the above-described condition is satisfied. If the condition is satisfied, the process proceeds to step S44. In this case, the m patients selected at step S41 are determined as representative patients. If the condition is not satisfied, the process proceeds to step S41.

(S44) The preprocessing unit 121 creates m data records in the representative patient table 113, and registers the patient information of the selected representative patients in the individual data records. In addition, the preprocessing unit 121 creates m data records in the patient group table 114 and registers a unique ID in each of the data records. Then, the preprocessing unit 121 registers the patient IDs of the selected representative patients in the individual data records in the patient group table 114.

(S45) The preprocessing unit 121 selects one of the representative patients.

(S46) The preprocessing unit 121 calculates, with reference to the map table 112, the distance (Euclidean distance) between the position of the representative patient selected at step S45 and the position of each of the other patients registered in the map table 112.

(S47) The preprocessing unit 121 selects all patients existing within a prescribed distance from the representative patient, from among the other patients for which the distances are calculated at step S46. The preprocessing unit 121 registers the patient ID of each of the selected patients in the data record corresponding to the representative patient in the patient group table 114.

(S48) The preprocessing unit 121 determines whether all the representative patients have been selected. If there is any unselected representative patient, the process proceeds to step S45. If all of the representative patients have been selected, the process is completed.

In this connection, the process of FIGS. 11 and 12 may be performed by an information processing apparatus different from the server 100, for example.

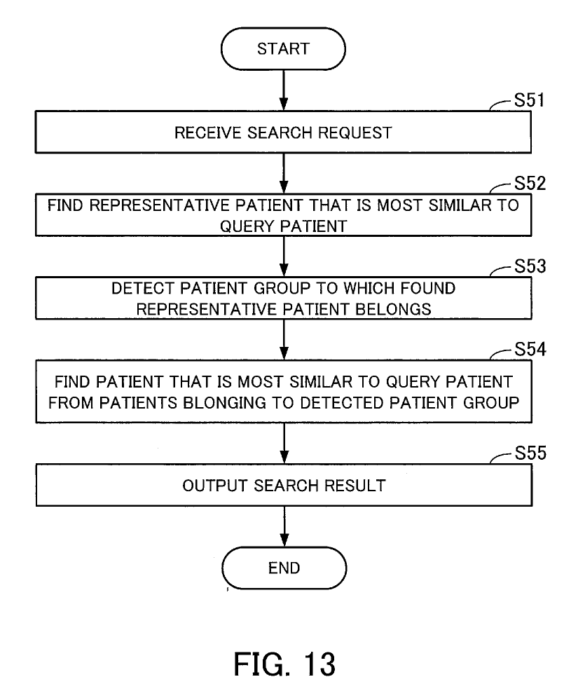

FIG. 13 is a flowchart illustrating an example of a similarity search process. The process of FIG. 13 will be described step by step.

(S51) The search unit 122 receives a search request for searching for a patient similar to a query patient, from the terminal device 200. The search request includes the patient information record of the query patient. Alternatively, the search request may include only a patient ID identifying the query patient. In this case, the search unit 122 retrieves the patient information record corresponding to the patient ID included in the search request, from the patient database 111. In this connection, in the following processing, out of the patient information records registered in the patient database 111, the patient information records other than the patient information record of the query patient are searched.

(S52) The search unit 122 retrieves the patient information records of all representative patients from the representative patient table 113, and then calculates the degree of similarity between the patient information record of the query patient and the patient information record of each representative patient. The search unit 122 finds a representative patient whose patient information record is the most similar to that of the query patient, on the basis of the calculated degrees of similarity.

(S53) The search unit 122 detects a patient group to which the found representative patient belongs, with reference to the patient group table 114.

(S54) The search unit 122 retrieves the patient information records of all patients belonging to the detected patient group from the patient database 111. The search unit 122 then calculates the degree of similarity between the patient information record of the query patient and each of the retrieved patient information records. The search unit 122 finds a patient whose patient information record is the most similar to that of the query patient, on the basis of the calculated degrees of similarity.

(S55) The search unit 122 outputs the patient ID or patient information record of the patient found at step S54 as a result of the similarity search to the terminal device 200. Then, the process is completed.

In this connection, the information processing of the first embodiment is implemented by causing the processor provided in the search apparatus 1 to execute an intended program, for example. The information processing of the second embodiment is implemented by causing the processor 101 to execute an intended program. Such a program may be recorded on a computer-readable recording medium.

For example, recording media on which the program is recorded are put on sale, thereby making it possible to distribute the program. In addition, different programs may be created for implementing the functions of the preprocessing unit 121 and the search unit 122, and then may be distributed separately. Furthermore, the functions of the preprocessing unit 121 and the search unit 122 may be implemented by different computers. For example, the computer may store (install) the program from the recording medium to a storage device, such as the RAM 102 or HDD 103, read the program from the storage device, and execute the program.

According to one aspect, it is possible to reduce the time needed for a similarity search on patient information.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable storage medium storing a computer to perform a process comprising:
retrieving, from a storage device, a plurality of representative patient information records among a plurality of patient information records about respective ones of a plurality of patients, the storage device storing therein the plurality of patient information records, the plurality of representative patient information records respectively being representatives of a plurality of patient information groups, the plurality of patient information groups each being a set of patient information records similar to each other;
finding a first patient information record with a highest degree of similarity to a specified patient information record from among the plurality of representative patient information records;
retrieving, from the storage device, patient information records included in a specific patient information group to which the first patient information record belongs among the plurality of patient information groups; and
finding a second patient information record with a highest degree of similarity to the specified patient information record from among the patient information records included in the specific patient information group.

2. The non-transitory computer-readable storage medium according to claim 1, wherein, with reference to a coordinate space where the plurality of patient information records are mapped, the plurality of representative patient information records are selected from the plurality of patient information records, positions of the plurality of representative patient information records being distributed in the coordinate space, the coordinate space being set such that a distance between points corresponding to patient information records represents a degree of non-similarity between the patient information records corresponding to the points.

3. The non-transitory computer-readable storage medium according to claim 2, wherein patient information records belonging to each of the plurality of patient information groups are positioned within a prescribed distance from a position of a corresponding one of the plurality of representative patient information records in the coordinate space.

4. The non-transitory computer-readable storage medium according to claim 2, wherein the process further includes:
randomly selecting a prescribed number of patient information records from the plurality of patient information records, and
designating, when an index indicating a degree of similarity between a degree of distribution of positions corresponding to the plurality of patient information records in the coordinate space and a degree of distribution of positions corresponding to the prescribed number of patient information records in the coordinate space is greater than or equal to a prescribed threshold, the prescribed number of patient information records as the plurality of representative patient information records.

5. The non-transitory computer-readable storage medium according to claim 2, wherein the coordinate space is set using one of principal component analysis and multidimensional scaling, based on the plurality of patient information records.

6. A search method comprising:
retrieving, by a computer, from a storage device, a plurality of representative patient information records among a plurality of patient information records about respective ones of a plurality of patients, the storage device storing therein the plurality of patient information records, the plurality of representative patient information records respectively being representatives of a plurality of patient information groups, the plurality of patient information groups each being a set of patient information records similar to each other;
finding, by the computer, a first patient information record with a highest degree of similarity to a specified patient information record from among the plurality of representative patient information records;
retrieving, by the computer, from the storage device, patient information records included in a specific patient information group to which the first patient information record belongs among the plurality of patient information groups; and
finding, by the computer, a second patient information record with a highest degree of similarity to the specified patient information record from among the patient information records included in the specific patient information group.

7. A search apparatus comprising:
a memory configured to store therein at least a plurality of representative patient information records among a plurality of patient information records about respective ones of a plurality of patients, the plurality of representative patient information records respectively being representatives of a plurality of patient information groups, the plurality of patient information groups each being a set of patient information records similar to each other; and
a processor configured to perform a process including
finding a first patient information record with a highest degree of similarity to a specified patient information record from among the plurality of representative patient information records, and
finding a second patient information record with a highest degree of similarity to the specified patient information record from among patient information records included in a specific patient information group to which the first patient information record belongs among the plurality of patient information groups.
